(19) United States
(12) Patent Application Publication
(10) Pub. No.: US 2019/0250045 A1
(43) Pub. Date: Aug. 15, 2019

(54) TEMPERATURE GAUGE DISPLAY AND A METHOD OF USING THE SAME TO DETERMINE WHEN A SATURATED STEAM TEMPERATURE FOR A GIVEN SATURATED STEAM PRESSURE IS IN THE UNACCEPTABLE SUBCOOLED RANGE

(71) Applicant: Gary Wayne Gleason, Germantown, TN (US)

(72) Inventor: Gary Wayne Gleason, Germantown, TN (US)

(21) Appl. No.: 16/273,543

(22) Filed: Feb. 12, 2019

Related U.S. Application Data
(60) Provisional application No. 62/630,085, filed on Feb. 13, 2018.

(51) Int. Cl. G01K 1/04; G01K 13/00; G01K 1/02; G01K 1/06

(52) U.S. Cl. CPC G01K 1/045; G01K 1/06; G01K 1/028; G01K 13/00

(57) ABSTRACT

A temperature gauge display and a method of using the same to determine whether a saturated steam temperature is as it should be or if the saturated steam temperature is in the unacceptable subcooled range. The gauge display embodies a dial face providing a pointer movable along the dial face in the clockwise directions for indicating steam system temperature while an arcuate colored portion is located along a portion of the path of the pointer so that the pointer, the dial face, and the colored portion visually cooperate to indicate sufficient operation of the system being monitored, wherein the colored portion defines a subcooled range of saturated steam temperature for a specific saturated steam pressure.

### CROSS-REFERENCE TO RELATED APPLICATION

This application claims the benefit of priority of U.S. provisional application No. 62/630,085, filed 13 Feb. 2018, the contents of which are herein incorporated by reference.

### BACKGROUND OF THE INVENTION

The present invention relates to temperature gauges and, more particularly, a temperature gauge display and a method of using the same to determine when a saturated steam temperature for a given saturated steam pressure is in the unacceptable subcooled range.

Operating an industrial, institutional, or commercial facility typically requires a steam system. A few examples of steam usage could be industrial processes, heating a building, or heating water for domestic use. The only thing we ever want in a steam system is steam. Once the steam condenses (becomes water again), it needs to be removed from the system immediately. If a saturated steam system at a given saturated pressure is operating below saturated temperature, that is a signal that there is water in the steam system. If it is not eliminated, it can cause heat transfer problems because water is an insulator, or it can cause a seriously unsafe condition called water hammer which damages system components and can cause injury or death of personnel. Also, if the steam system is not operating at peak efficiency, then the cost of operating the system increases unnecessarily. Facility personnel need an easy, at-a-glance, visual indication to determine if steam temperature for a given saturated steam pressure is below saturated temperature. In other words, to easily determine if the saturated steam temperature is less than it should be (or “subcooled”) for the saturated steam pressure of the system.

The standard temperature gauge dial (or face), unfortunately, does not show the saturated steam subcooled temperature range for a particular saturated steam pressure. Other devices may offer a temperature reading, but do not indicate specifically or directly when the saturated steam temperature is less than what it should be for the saturated steam pressure in the piping. As a result, personnel do not have a quick and easy way to glance at the temperature gauge and determine that the saturated steam temperature is what it should be or if it is subcooled (the temperature is below the saturated temperature for the saturated pressure at which the steam system is operating).

As can be seen, there is a need for a temperature gauge display and a method of using the same to determine when a saturated steam temperature is what it should be or if it is in the subcooled range (below what it should be for the given saturated steam pressure), thereby enabling facility personnel to easily and quickly (at a glance) determine if there are potential safety, productivity, or efficiency issues.

### SUMMARY OF THE INVENTION

In one aspect of the present invention, a method of visually arranging a dial face of a saturated steam temperature gauge for indicating an unacceptable (subcooled) range of temperature for a given saturated steam pressure includes representing the given pressure on the dial face; and representing the unacceptable subcooled range of temperatures through a colored portion along the dial face, wherein the colored portion contrasts in color with adjacent portions of the dial face.

In another aspect of the present invention, a method of visually arranging a dial face of a temperature gauge for indicating an unacceptable (subcooled) range of temperatures for a given saturated steam pressure includes providing a temperature pointer movable in at least a clockwise path along the dial face; providing an indicium of the given saturated steam pressure on the dial face; and representing the unacceptable (subcooled) range of saturated steam temperatures through a colored portion along the dial face, wherein the colored portion contrasts in color with adjacent portions of the dial face, wherein the colored portion is an arcuate shape along the dial face in the path of the pointer.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use;

FIG. 2 is a perspective view of an exemplary embodiment of the present invention, shown in use; and

FIG. 3 is a front elevation view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a temperature gauge display and a method of using the same to determine when a saturated steam temperature is in the unacceptable subcooled range. The gauge display embodies a dial face providing a pointer movable along the dial face in clockwise directions and an arcuate colored portion located along a portion of the path of the pointer so that the pointer, the dial face and the colored portion visually cooperate to give an indication of sufficient operation of the steam system being monitored, wherein the colored portion defines a subcooled range of saturated steam temperature for a specific saturated steam pressure.

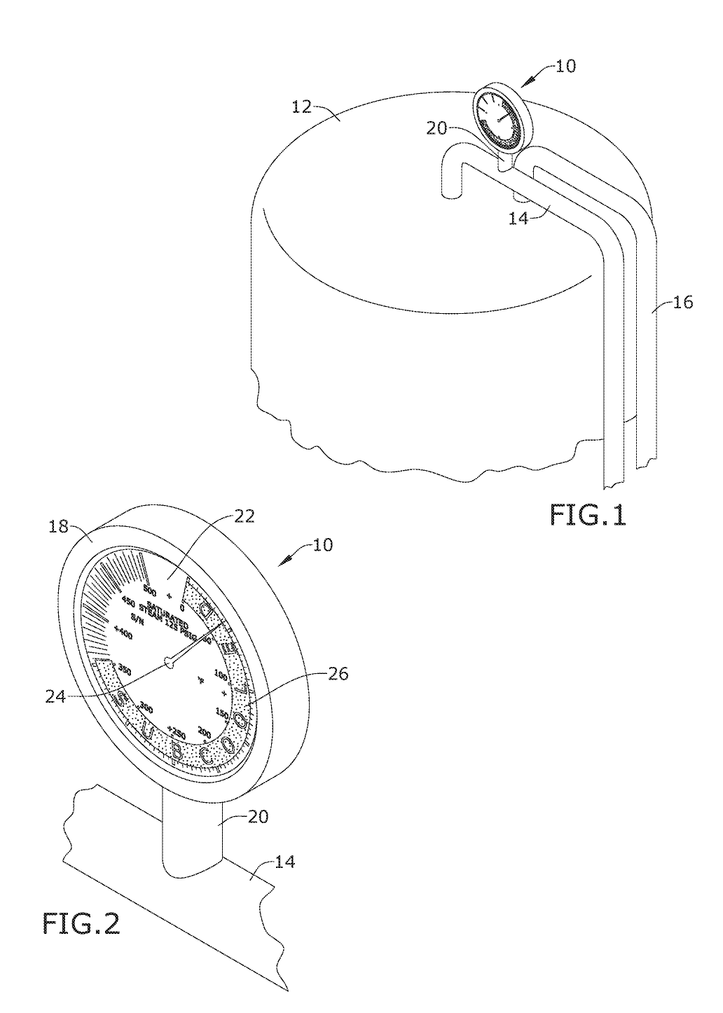

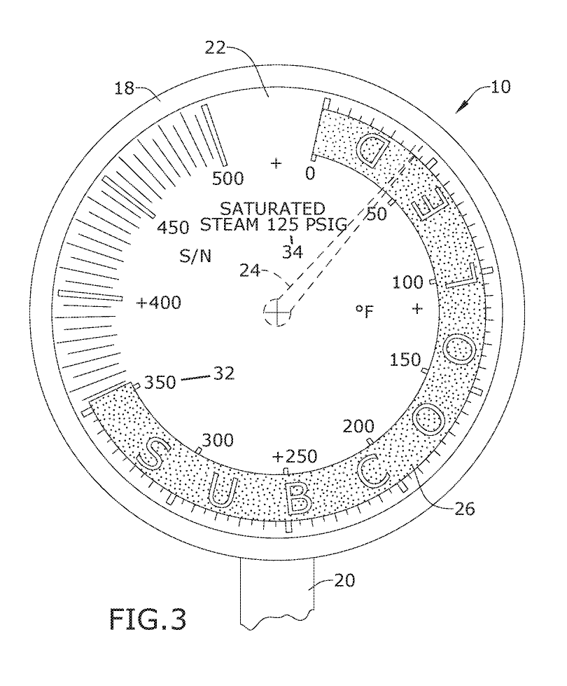

Referring now to FIGS. 1 through 3, the present invention may provide a temperature gauge display 22 for determining at-a-glance whether a saturated steam temperature is in the unacceptable subcooled range.

The temperature gauge 10 adapted to sense temperature may include a gauge housing 18 having a visible dial face 30 with fixed markings corresponding to respective temperature values. The dial face 30 has a plurality of pressure scale graduations 32 visible through a transparent window providing by the gauge housing 18. A gauge pointer 24 is movable in the both the clockwise and counterclockwise direction along the dial face in response to the temperature values sensed by the temperature gauge 10.

The dial face 30 provides an arcuate colored portion 26 located along a portion of the path of the pointer 24 so that the pointer 24, dial face 30 and the arcuate colored portion 26 visually cooperate to give an indication of sufficient operation of the system being monitored. The boundaries of the arcuate colored portion 26 defines the limits of the sufficient operating range. Thus, when the pointer 24 is outside the range indicated by the arcuate colored portion 26, the system is operating properly. The unacceptable (subcooled) operating range represented by the arcuate colored portion 26 may identify the saturated steam temperature subcooled range for a specific or selected saturated steam pressure. The position of the pointer 24 indicative of temperature and the arcuate colored portion 26 representing saturated steam temperature visually show the relationship between the temperature as indicated and the range of saturated steam subcooled temperature for a particular saturated steam pressure.

Attached to the housing 18 may be a mounting stem 20 providing a valve to fluidly communicate the temperature gauge 10 and a steam system component. The steam system component may be a saturated steam tank 12 having inlet piping 14 and outlet piping 16, wherein the mounting stem 20 is connected to the inlet piping 14, as illustrated in FIG. 1.

A method of using the present invention may include the following. The temperature gauge 10 having the temperature gauge display 22 disclosed above may be provided. A user may operatively associate the temperature gauge 10 with steam piping. The temperature gauge 10 may be used to measure the temperature of the steam or condensate in the steam piping or to measure the surface temperature of the steam piping. By reading its unique dial face 30, personnel can easily, quickly, and at-a-glance, determine if the temperature of what is in the steam pipe is at saturated temperature for any given saturated steam pressure. The “subcooled” range or zone, as printed on the gauge dial in the form of the arcuate colored portion 26, makes it easy to determine if the temperature is below saturated steam temperature for the specific saturated steam pressure. When temperature is below saturated steam temperature at a given saturated steam pressure, then there could be a safety, production, or efficiency problem that needs to be addressed.

Examples of the appropriate subcooled ranges include the following: at 100 psig, any temperature below 338 degrees Fahrenheit is subcooled; at 125 psig anything below 353 Fahrenheit degrees is subcooled, and at 150 psig anything below 366 Fahrenheit degrees is subcooled, pursuant to appropriate saturated steam tables showing the relationship between the saturated steam pressure and saturate steam temperature.

An indicium 34 of the given saturated steam pressure may be represented on the dial face 30.

The temperature gauge display 22 could also be used as part of a standard steam temperature gauge or thermometer.

It should be understood, of course, that the foregoing relates to exemplary embodiments of the invention and that modifications may be made without departing from the spirit and scope of the invention as set forth in the following claims.

What is claimed is:

1. A method of visually arranging a dial face of a temperature gauge for indicating an acceptable range of temperatures for a given saturated steam pressure, comprising:
representing the given pressure on the dial face; and
representing the unacceptable range of temperatures through a colored portion along the dial face, wherein the colored portion contrasts in color with adjacent portions of the dial face.

2. The method of claim 1, wherein the representative given pressure is an indicium on the dial face.

3. The method of claim 1, further comprising providing a temperature pointer movable in at least a clockwise path along the dial face, wherein the colored portion is an arcuate shape along the dial face in the path of the temperature pointer.

4. The method of claim 1, wherein the unacceptable range of temperatures are subcooled saturated steam temperatures, and wherein the given pressure is a saturated steam pressure.

5. A method of visually arranging a dial face of a temperature gauge for indicating an acceptable range of temperatures for a given saturated steam pressure, comprising:
providing a temperature pointer movable in at least a clockwise path along the dial face;
providing an indicium of the given saturated steam pressure on the dial face; and
representing the unacceptable subcooled range of saturated steam temperatures through a colored portion along the dial face, wherein the colored portion contrasts in color with adjacent portions of the dial face, wherein the colored portion is an arcuate shape along the dial face in the path of the pointer.
